(19) United States
(12) Patent Application Publication
(10) Pub. No.: US 2026/0294052 A1
(43) Pub. Date: Oct. 1, 2026

(54) SLIDER FOR SLIDE FASTENER, SLIDE FASTENER AND FASTENABLE OBJECT

(71) Applicant: YKK CORPORATION, Tokyo (JP)

(72) Inventors: Massimiliano DI GIROLAMI, Ascoli Piceno (IT); Mauro CASTELLI, Ascoli Piceno (IT); Pietro BRUNI, Ascoli Piceno (IT); Shinya HONDA, Ascoli Piceno (IT)

(21) Appl. No.: 19/578,793

(22) Filed: Mar. 25, 2026

(30) Foreign Application Priority Data
Mar. 26, 2025 (DE) 202025101644.3

(51) Int. Cl. A44B 19/26; B60N 2/60

(52) U.S. Cl. CPC A44B 19/26; B60N 2/6018

(57) ABSTRACT

A slider for a slide fastener includes: a lower plate; a guide column extending from the lower plate; a puller mount extending from the guide column; a pair of sidewalls extending along a sliding direction of the slider and being arranged on both sides of the guide column; and a pair of upper plates, each of the upper plates extending from a corresponding one of the sidewalls and being arranged so as to extend towards the guide column. The slider further includes a neck section that is arranged between the guide column and the puller mount.

### CROSS-REFERENCE TO RELATED APPLICATIONS

This application is based on and claims priority under 35 USC § 119 from German Utility Model Application No. 202025101644.3 filed on Mar. 26, 2025, the contents of which are incorporated herein by reference.

### TECHNICAL FIELD

The present invention relates to a slider for a slide fastener.

### BACKGROUND

Slide fasteners are used in a variety of fields in order to close, for example, garments but are also often used in, for example, the automobile industry when, for example, wishing to connect different parts of a car seat to each other in a detachable manner.

There are different types of fasteners. One type of fastener, which often finds use in, for example, the flies of trousers or in order to close coats or other types of clothing, has an arrangement where the fastener tapes of the slide fastener have metal or plastic teeth which are visible to the outside. To improve the aesthetic appearance, those teeth are typically covered by a piece of cloth so that they are not visible to the outside. However, in other contexts, those teeth are visible to users. With such fasteners, the fastener tapes extend to the left and right sides of the slider relative to the fastening or sliding direction.

It is to be noted that in the context of the present disclosure, the term “up” refers to the direction in which a puller (to be discussed later) is attached to a slide fastener, and the term “down” is the direction opposite to the upwards direction. The term “left” and “right” refer to the left and right sides when viewed along the direction in which the slider slides to attach fastener tapes to each other. The term “forward” refers to the direction in which the slider is slid when attaching the fastener tapes to each other, whilst the term “backward” refers to the direction that is opposite to the forward direction and in which the slider detaches fastener tapes from each other.

A different type of slide fastener is a slide fastener that is designed so that the fastener elements are less visible to the outside. In that case, due to the way in which the fastener tapes are routed, the fastener elements (and, to some extent, the fastener tapes to which the fastener elements are attached) are buried inside the object which has the slide fastener attached thereto so that the fastener tapes and, even more so, the fastener elements are less visible, or even invisible, to the outside. In those cases, both fastener tapes extend from the upper end of the slide fastener and only then extend to the left and right. Thus, since the fastener elements are hidden inside the thus created crease, the fastener elements are less visible to the outside. Such a configuration often finds use in, for example, the automobile industry where such slide fasteners are used for attaching different cushion covers of a car seat to one another. The details of such a slide fastener design can, for example, be taken from EP2578106A1.

A related slider design that is somewhat similar to the design of EP2578106A1 is shown in FIG. 1. As can be seen from FIG. 1, a slider 1′ has a puller mount 6′ at an upper end thereof. This puller mount 6′ is used for sliding a slider body 50′ relative to two fastener tapes (not shown) which would emerge from the top of the slider body 50′. Due to the emerging fastener tapes, a puller (not shown) which is attached to the puller mount 6′ may interfere with the fastener tape and any material that is connected to that tape. This can then lead to the puller damaging the material connected to the fastener tapes and/or sticking up relative to the fabric, as can be seen from FIG. 8, where a related slider 1′ is shown with a puller 7′ attached thereto. Such a situation is less aesthetically pleasing. Furthermore, this makes an accidental contact and an accidental actuation of the puller 7′ more likely.

The present invention aims at providing a slider for a slide fastener which avoids those issues and which, in particular, allows for a slider which is less interference-prone and more aesthetically pleasing. The invention furthermore aims at providing a slide fastener having such a slider and a fastenable object having a corresponding slide fastener.

### SUMMARY

There is provided a slider for a slide fastener having two fastener tapes bent and fixed in a U-shape, the slider configured to attach or detach fastener elements which are attached along an end edge of the bent fastener tapes. The slider includes: a lower plate; a guide column extending from the lower plate and configured to guide the two fastener tapes; a puller mount configured to hold a puller, the puller mount extending from the guide column; a pair of sidewalls extending along a sliding direction of the slider, each of the pair of sidewalls being arranged on a corresponding one of both sides of the guide column, the sidewalls configured to guide each of the fastener tapes between each of the sidewalls and the guide column; and a pair of upper plates, each of the upper plates extending from a corresponding one of the sidewalls and being arranged so as to extend towards the guide column. The slider further includes a neck section that is arranged between the guide column and the puller mount.

In the slider, the neck section may have a length measured perpendicularly to the lower plate, the length being within a range from 1 mm to 10 mm.

In the slider, the length may be within a range from 2 mm to 4 mm.

In the slider, the length may be greater than or equal to 70% of a distance between a bottommost surface of the lower plate and a topmost surface of one of the upper plates.

In the slider, the guide column may include a first section that is tapered in the sliding direction. The neck section may include a second section that is tapered in the sliding direction so that both the first section and the second section are tapered at the same side in the sliding direction.

In the slider, the same side in the sliding direction may face in a direction in which the slider is to slide to attach the fastener elements to each other.

In the slider, at at least one end in the sliding direction, at least one of the upper plates may be coterminous with a corresponding one of the sidewalls from which the at least one of the upper plates extends.

In the slider, at both ends in the sliding direction, at least one of the upper plates may be coterminous with a corresponding one of the sidewalls from which the at least one of the upper plates extends.

In the slider, at at least one end in the sliding direction, all of the upper plates may be coterminous with each of the corresponding sidewalls from which each of all of the upper plates extends.

In the slider, at both ends in the sliding direction, all of the upper plates may be coterminous with each of the corresponding sidewalls from which each of all of the upper plates extends.

There is also provided a slide fastener including the slider according to any one of the above aspects.

There is also provided a fastenable object including the slide fastener as described above and two sections made of flexible material which are configured to be fastened together by the slide fastener, the slide fastener including the puller movably held by the puller mount, the neck section being arranged so that the puller is, at least partially, freely movable relative to the puller mount without interference by the flexible material.

In the fastenable object, the fastenable object may be a car seat. The flexible material may include natural and/or artificial leather.

### BRIEF DESCRIPTION OF DRAWINGS

FIG. 1 shows a slider according to the related art.

FIG. 2 shows a side view of a slider according to the present invention.

FIG. 3 shows a top view of the slider according to the present invention.

FIG. 4 shows a front view of the slider according to the present invention.

FIG. 5 shows a perspective view of the slider according to the present invention.

FIG. 6 shows an exploded view of the slider according to the present invention.

FIG. 7 shows the slider according to the present invention in a slide fastener with flexible material attached thereto.

FIG. 8 shows a fastenable object having a slider according to the present invention and the related slider attached thereto.

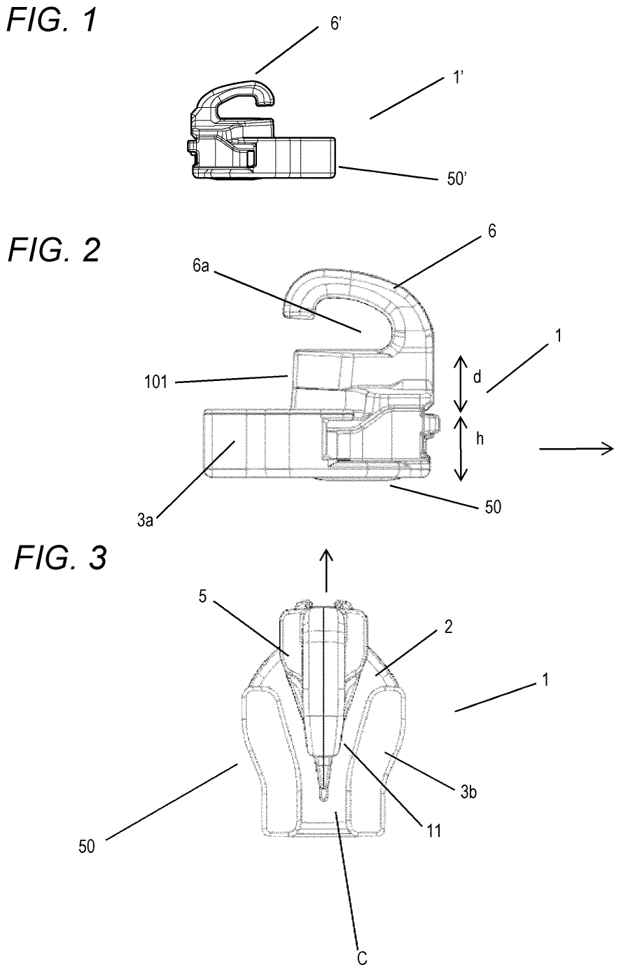

### DESCRIPTION OF EMBODIMENTS

In the following, one embodiment of the present invention will be described by reference to the attached figures.

FIG. 2 shows a side view of the slider 1 according to the present invention. A puller mount 6 is connected to a slider body 50 by a neck section 101 which extends vertically with respect to the slider body 50. The slider body 50 has, as is shown in more detail in the top view of FIG. 3, a lower plate 2 which has a pair of sidewalls 3a attached thereto, which extend upwardly, as can be seen from FIG. 2. Those sidewalls 3a are arranged on the left and right sides of the slider body 50 with respect to the sliding direction, which is indicated by an arrow in FIGS. 2 and 3. The slider body 50 further includes the sidewalls 3a, the guide column 5, and the upper plates 3b.

From FIG. 3, the overall shape of the guide column 5 which extends from the lower plate 2 can be seen more clearly. The guide column 5 has a shape which tapers towards the bottom of the page of FIG. 3, which is the rearward direction. Accordingly, if the slider 1 shown in FIG. 3 is moved as indicated by the arrow, the slider 1 will attach the fastener elements of the fastener tape, which is used with the slider 1, to each other.

The tops of the sidewalls 3a are attached to the upper plates 3b which extend inwardly from the sidewalls 3a attached thereto. Those upper plates 3b create a gap 11 between each of the upper plates 3b and the guide column 5. Through the gap 11, fastener tapes (not shown in FIG. 3) will extend when the slider 1 is in use. Thus, the sidewalls 3a and the upper plates 3b as well as the lower plate 2 and the guide column 5 define a channel C therebetween, the channel C through which fastener elements 13 of the slide fastener are led. This channel C, which is opened to the outside via the gap 11 and via the inlet and the outlet at the front and rear ends in the sliding direction of the slider 1, has, in the top view, the shape of a letter Y, where the single leg of the Y is a part of the slider at which the fastener tapes are connected to each other and where the upper legs of the letter Y denote parts of the slider at which the fastener tapes are separated from each other.

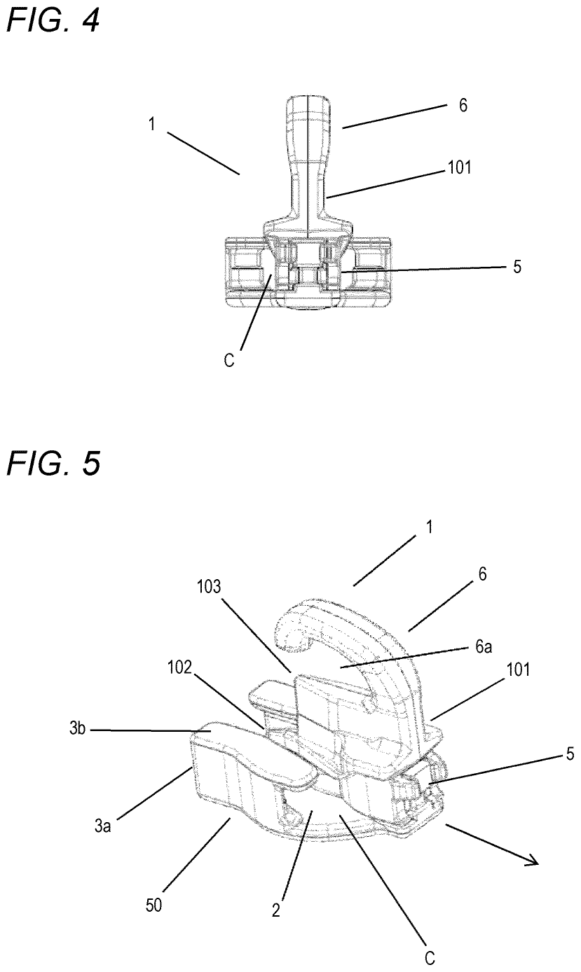

FIG. 4 shows a front view of the slider 1. From this view, the channel C discussed previously can be seen more clearly as extending from the front to the rear end of the slider 1. From this figure, also the neck section 101 can be seen. This neck section 101 separates the uppermost surface of the upper plates 3b and the bottommost part of the hole forming part of the puller mount 6 from each other by a distance d as shown in FIG. 2. This distance d serves to create some freedom of movement for a puller which is held inside the hole 6a of the puller mount 6 and when using materials which is to be fastened to each other using the slider 1 and which extend upwardly from the slider 1. That is, due to this gap which is created by the neck section 101, a puller attached to the puller mount 6 will not be held in an upright position by the material of the slide fastener or of a material with which the slide fastener is used.

FIG. 5 shows the slider 1 in a perspective view where also the shape of the channel C can be seen more clearly. From this figure, it is possible to more clearly see the tapered first section 102 of the guide column 5 which is arranged at the bottom of the slider body 50 as well as the tapered second section 103 which is part of the neck section 101. The first section 102 serves to aid in separating fastener elements from each other whilst the second section 103 helps in pushing the materials, to which the fastener elements or the attached fastener tape are connected, away from each other.

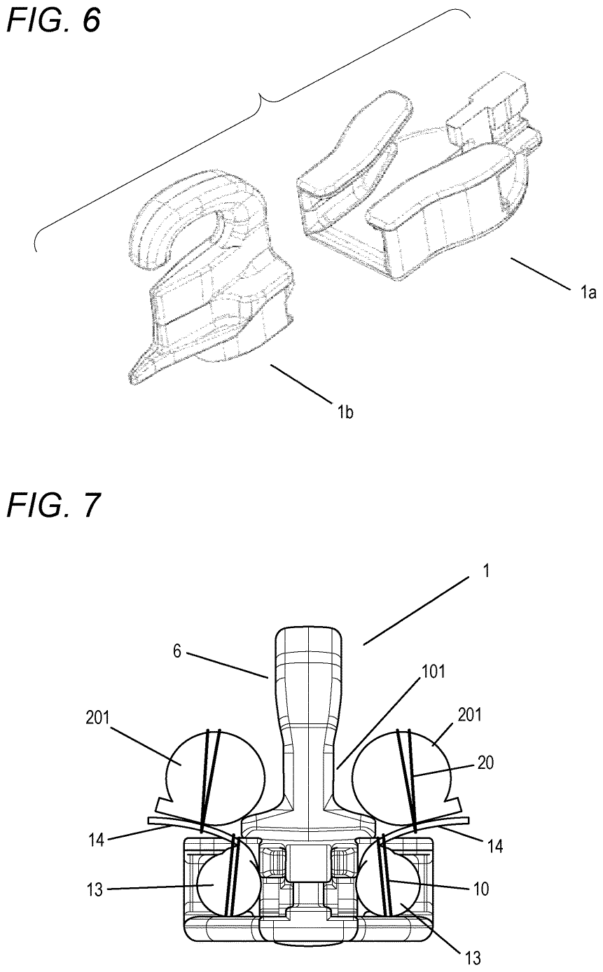

FIG. 6 shows in an exploded view of the slider 1. As can be seen from this figure, the slider 1 includes two components 1a, 1b which are configured to be attached to each other, for example by caulking, as is discussed in EP2578106A1, paragraphs [0092] and [0093].

FIG. 7 shows a configuration where a fastenable object has two of components connected to each other by using a slider 1 according to the present invention. As can be seen from this drawing, fastener elements 13 are arranged inside the channel C of the slider and are, by the sliding movement of the slider 1, connected to each other. The fastener element 13 is attached to the fastener tape 14 by a first string 10. In that way, the fastener tapes 14 which are attached to the fastener elements 13 are also pulled close to each other. In turn, this connects the flexible materials 201 to each other. Due to the neck section 101, the puller mount 6 sticks out from the flexible materials 201, which thus means that a puller attached to the puller mount 6 will be able to lie down flatly on the flexible materials 201, rather than sticking up. Further, the flexible material 201 is attached to the fastener tape 14 by a second string 20. Since the movement between the flexible material 201 and the fastener tape 14 is restricted by the second string 20, it is possible to suppress the flexible material 201 from unnecessarily interfere with the neck section 101, and ultimately, with the puller mount 6. Further, it is possible to suppress the puller mount 6 from being concealed.

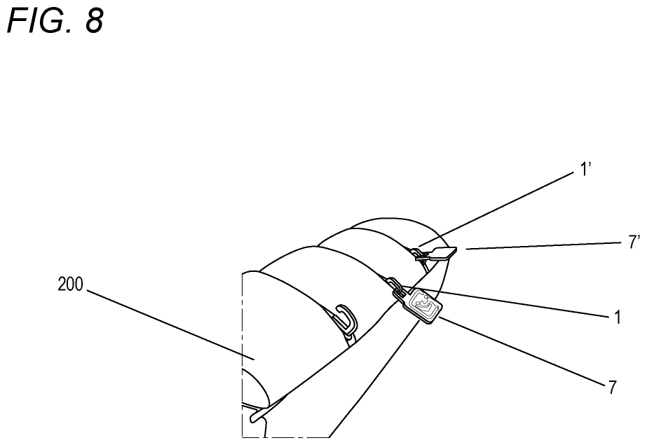

This effect is shown in FIG. 8 where a slider 1′ according to the related art has a puller 7′ attached thereto. As can be seen from this figure, due to the interference of the puller 7′ with the flexible material of the fastenable object 200, the puller 7′ sticks up. In contrast with this, the puller 7 attached to a slider 1 according to the present invention lies down flat on the material of the fastenable object and is thus less likely to cause interference.

According to the present invention, a slider for a slide fastener is configured to have two fastener tapes bent and fixed in a U-shape and emerging at the top of the slider or the slider body. The slider is configured to attach or detach fastener elements which are attached along an end edge of the bent fastener tape. By the two fastener tapes being bent and fixed in a U-shape, they are arranged so that the fastener elements are hidden inside the crease formed by the two attached bent fastener tapes. That is, the present invention relates to the configuration with hidden fastener elements.

According to the present invention, the slider includes a lower plate. This lower plate is arranged as a bottommost structure of the slider and has the further components of the slider that are arranged on the lower plate and that are used for attaching or detaching the fastener elements.

A guide column is arranged on the lower plate so as to extend upwards therefrom. The guide column is to be arranged between the two non-attached fastener tapes and will either separate the fastener tapes when detaching fastener tapes or will guide the fastener tapes towards each other (together with further components to be discussed below) when attaching the fastener tapes to each other. Thus, the guide column is arranged at a central position in the left-right direction.

The guide column has a puller mount arranged thereon. This puller mount can, in embodiments, take the form of a hook which can hold a puller. It can also take the form of a loop where the puller extends through the opening of the loop. The puller mount is arranged so as to extend from the guide column so that by pulling the puller, a force is exerted to the puller mount, which is, in turn, applied to the slider or the slider body to thus slide the slider or the slider body. As a consequence of this sliding motion, the fastener elements are attached or detached with respect to each other in the way that is, for example, described in EP2578106A1. This attachment or detachment in turn fastens or unfastens the objects that are attached to the slide fastener.

The slider further includes a pair of sidewalls. The sidewalls extend along the sliding direction of the slider and are arranged on both sides of the guide column. The sidewalls extend from the lower plate. The sidewalls will, when the slider is in use, sandwich one of the fastener tapes between one of the sidewalls and the guide column, and each and either of the sidewalls guides the fastener tapes towards each other so as to attach the fastener tapes to each other or guide the fastener tapes away from each other so as to detach or separate the fastener tapes when sliding the slider forward or rearward.

At upper ends of the sidewalls, upper plates are arranged which extend inwardly towards the guide column from the sidewalls. Those upper plates leave a gap between each of the upper plates and the guide column. Through the gap, the fastener tape is led when in use.

According to the present invention, the slider includes a neck section which is arranged between the guide column and the puller mount. That is, the neck section is arranged so that the puller mount is not arranged directly on top of the guide column. This neck section can take the form of a piece of material which is arranged between the bottommost part of the puller mount which can be used for attaching a puller and an uppermost surface of the upper plates. That is, by the neck section, it is ensured that there is some space between the topmost portion of the upper plates and the bottommost part of the puller mount to which a puller could be attached. For example, in the case of a puller mount forming a hook, the neck portion makes sure that the bottommost portion of the area defined by the hook and the topmost surface of the upper plates are spaced apart from each other by a distance d. In the case of the puller mount forming a loop, the distance d is defined to be the distance between the topmost surface of the upper plates and the lowermost part of the hole encircled by the loop through which the puller is to be threaded.

By the neck section, the point at which the fastener tapes emerge from the gap between the guide column and each of the upper plates and the puller is increased. This gives some room for the puller to move so that the puller can be avoided that the puller will be held up or otherwise interfere with the material which is fastened together by the slide fastener. Accordingly, the corresponding slider is less prone to interference and leads to a more aesthetically pleasing overall appearance.

It is preferred that the neck section has a length d measured perpendicularly to the lower plate which is within the range greater than or equal to 70% of the height h of the slider body, preferably within a range from 70% to 100% of the height h of the slider body. In embodiments, this leads to a length d of being within a range from 1 mm to 10 mm, more preferably within the range from 2 mm to 4 mm. Having such a length has been shown for being particularly useful with most textile and other types of flexible materials (in particular natural and artificial leather) to be used with slide fasteners. The height h of the slider body is the distance between the topmost surface of the upper plates and the bottommost surface of the lower plate.

In embodiments, the guide column includes a first section that is tapered in the sliding direction. With such a first section, the guide column aids in separating fastener elements to detach them from one another or also in bringing the fastener elements together so as to attach them to each other. It is preferred that also the neck section includes a second section that is also tapered at the same side in the sliding direction. Thus, also the neck section can aid in either moving apart the connected parts of material or in bringing them together. Thus, both the first section and the second section aid in attaching or detaching the two fastener tapes.

It is also preferred that at at least one end in the sliding direction, and preferably at both ends in the sliding direction, at least one and preferably all of the upper plates are coterminous with the respective sidewall from which the upper plate extends. That is, each of the upper plates does not extend beyond the sidewall to which the corresponding upper plate is attached in the sliding direction but ends at the same point in the sliding direction at which the sidewall to which the corresponding upper plate is attached ends. This reduces the size of the slider and also thus reduces the deformation of the fastened material and the visibility of the slider to the outside.

Another aspect of the invention is a slide fastener which includes the slider according to one of the preceding embodiments. A corresponding slide fastener combines the advantages recited previously.

According to another aspect of the invention, a fastenable object is provided, which includes a slide fastener as described previously. This fastenable object further includes two sections made of flexible material which are fastened together by the slide fastener. The slide fastener includes a puller movably held by the puller mount. The neck section is arranged so that the puller is, at least partially, freely movable relative to the puller mount and without interference by the flexible material. That is, the puller is free from interference by the flexible material so that the puller can at least to some extent swing freely relative to the puller mount without being hindered by the flexible material. Accordingly, the neck section is long enough to sufficiently space apart the puller from the flexible material so that the puller has, at least to some degree, no interference with the flexible material and can thus lie down flatly on the flexible material without being held in a somewhat upright position relative to the flexible material.

It is preferred that the fastenable object is a car seat and that the flexible material preferably includes natural and/or artificial leather. With such a car seat, having a puller which does not stick up is particularly preferable so as to lead to a favourable appearance and so as to avoid accidentally interfering with the puller and/or damaging the material of the car seat.

What is claimed is:

1. A slider for a slide fastener having two fastener tapes bent and fixed in a U-shape, the slider configured to attach or detach fastener elements which are attached along an end edge of the bent fastener tapes, the slider comprising:
a lower plate;
a guide column extending from the lower plate and configured to guide the two fastener tapes;
a puller mount configured to hold a puller, the puller mount extending from the guide column;
a pair of sidewalls extending along a sliding direction of the slider, each of the pair of sidewalls being arranged on a corresponding one of both sides of the guide column, the sidewalls configured to guide each of the fastener tapes between each of the sidewalls and the guide column; and
a pair of upper plates, each of the upper plates extending from a corresponding one of the sidewalls and being arranged so as to extend towards the guide column,
wherein the slider further comprises a neck section that is arranged between the guide column and the puller mount.

2. The slider according to claim 1, wherein the neck section has a length measured perpendicularly to the lower plate, the length being within a range from 1 mm to 10 mm.

3. The slider according to claim 2, wherein the length is within a range from 2 mm to 4 mm.

4. The slider according to claim 2, wherein the length is greater than or equal to 70% of a distance between a bottommost surface of the lower plate and a topmost surface of one of the upper plates.

5. The slider according to claim 1,
wherein the guide column comprises a first section that is tapered in the sliding direction, and
wherein the neck section comprises a second section that is tapered in the sliding direction so that both the first section and the second section are tapered at the same side in the sliding direction.

6. The slider according to claim 5, wherein the same side in the sliding direction faces in a direction in which the slider is to slide to attach the fastener elements to each other.

7. The slider according to claim 1, wherein at at least one end in the sliding direction, at least one of the upper plates is coterminous with a corresponding one of the sidewalls from which the at least one of the upper plates extends.

8. The slider according to claim 7, wherein at both ends in the sliding direction, at least one of the upper plates is coterminous with a corresponding one of the sidewalls from which the at least one of the upper plates extends.

9. The slider according to claim 7, wherein at at least one end in the sliding direction, all of the upper plates are coterminous with each of the corresponding sidewalls from which each of all of the upper plates extends.

10. The slider according to claim 7, wherein at both ends in the sliding direction, all of the upper plates are coterminous with each of the corresponding sidewalls from which each of all of the upper plates extends.

11. A slide fastener comprising the slider according to claim 1.

12. A fastenable object comprising the slide fastener according to claim 11 and two sections made of flexible material which are configured to be fastened together by the slide fastener, the slide fastener comprising the puller movably held by the puller mount, the neck section being arranged so that the puller is, at least partially, freely movable relative to the puller mount without interference by the flexible material.

13. The fastenable object according to claim 12,
wherein the fastenable object is a car seat, and
wherein the flexible material comprises natural and/or artificial leather.
